(19) United States
(12) Patent Application Publication
(10) Pub. No.: US 2004/0179353 A1
(43) Pub. Date: Sep. 16, 2004

(54) Decorative light strings with combinative tree

(76) Inventor: Joseph Yao, Taipei (TW)

Correspondence Address: McGlew and Tuttle, P.C., Scarborough Station, Scarborough, NY, 10510-0827, US

(21) Appl. No.: 10/677,902

(22) Filed: Oct. 2, 2003

(30) Foreign Application Priority Data
Mar. 11, 2003 (CN) 03238505.6

(51) Int. Cl. F21S 6/00

(52) U.S. Cl. 362/123; 362/249

(57) ABSTRACT

The present invention relates to a kind of decorative light strings with combinative tree, including a long trunk to be composed of many short pipes, the height of tree lamp can be adjustable by the number of the short pipe; base frame is to use a support surface to erect the base frame and has a center axis to support long trunk to stand up right straight; multiple branches connect with the long trunk; single or multiple sets of light strings, composed of many lamp bulbs, lamp holders, electrical conductors and receptacles, to be fixed on the branches to establish tree light strings.

### BACKGROUND OF THE INVENTION

A conventional lamp light string set in a Christmas light string is consisting of a lamp bulb, lamp base, lamp holder, multiple electrical conductors, receptacles or flasher control, wherein the electrical conductors can be single or double or more than two wound into an electrical circuit. The distributed conductors can be formed in one, two or more than two electrical conductors, such as the FIG. 4 of U.S. Pat. No. 4,241,387 and the FIGS. 1 and 2 of the prior art in this case. In general, it is to use said electrical conductors to be wound in the trees. Such is troublesome and monotonous. Further, such kind of work is used several years. The present invention is an improvement in the defects of the conventional products. It is to use artificial trunks and branches of tree to make the decorative light strings along with the electrical connectors wound on the trees, so that the decorative light strings and branches of trees are to form a shape so as to obtain a decorative effect.

### SUMMARY OF THE INVENTION

The present invention is to make a conventional Christmas light strings be easy to transport and to make an improvement in the defects of the conventional products. The present invention relates to a kind of decorative light strings with combinative tree, including a long trunk to be composed of many short pipes, the height of tree lamp can be adjustable by the number of the short pipe; base frame is to use a supporting surface to erect the base frame and has a center axle to support long trunk to stand up right straight; multiple branches connect with the long trunk; single or multiple sets of light strings, composed of many lamp bulbs, lamp holders, electrical conductors and receptacles, to be fixed on the branches to establish tree light strings.

The present invention is to provide decorative light strings with combinative tree and its characteristic is to use the long trunk and said long trunk is composed of many hollow short pipes to be connected with each other.

The present invention is to provide decorative light strings with combinative tree and its characteristic is to use the short hollow pipes to be manufactured by metal. The present invention is to provide decorative light strings with combinative tree and its characteristic is to use the hollow short pipes having tenon for the convenience to fix it.

The present invention is to provide decorative light strings with combinative tree and its characteristic is an outer rim of one end of the short pipes at the predetermined distance of the open end having a flange. Another end has a predetermined length of L-indentation from the open end extending and matching the position of the flange. From the end having the flange, said flange is to aim at the open end of the L-indentation of another short pipe, to fit into the right position, then to rotate it to L-tail and to fix it tightly.

The present invention is to provide decorative light strings with combinative tree and its characteristic is to use the base part of L-indentation of the short pipe having an enlarge area so that the flange can be dovetailed into the enlarged area so as not to upside down and depart.

The present invention is to provide decorative light strings with combinative tree and its characteristic is the short pipes on the long trunk providing with one or more connecting rings to connect with many branches.

The present invention is to provide decorative light strings with combinative tree and its characteristic is the base frame to be composed of many branch frames. It is able to stretch out or to fold up from the center axle.

The present invention is to provide decorative light strings with combinative tree and its characteristic is the base part of branch frame having fastening ring. The pin is going through said fastening ring to nail into supporting surface and fix the base frame.

The present invention is to provide decorative light strings with combinative tree and its characteristic is the base frame to be stretched out from the center axle and base frame will not fall on a certain angle of supporting surface.

The present invention is to provide decorative light strings with combinative tree and its characteristic is the support surface used to erect the base frame able to be indoor and out door floor.

The present invention is to provide decorative light strings with combinative tree and its characteristic is the support surface used to erect the base frame able to be soften and hard floors at out door.

The present invention is to provide decorative light strings with combinative tree and its characteristic is to provide the hollow short pipe between the long trunk and base frame. Said hollow short pipe did not attach with branch and light string to increase the distance between this light string and supporting surface.

The present invention is to provide decorative light strings with combinative tree and its characteristic is to use light string having the protection device, transformer or functional control device to increase the decorative function.

The present invention relates to decorative light strings with combinative tree. It is another kind of decorative light strings with combinative tree including a long trunk to be composed of many short pipes, the height of tree lamp can be adjustable by the number of the short pipe; an outer rim of one end of the hollow short pipes at the predetermined distance of the open end having a flange. Another end has a predetermined length of L-indentation from the open end extending and matching the position of the flange. From the end having the flange, said flange is to aim at the open end of the L-indentation of another short pipe, to fit into the right position, then to rotate it to L-tail and to fix it tightly; base frame is to use a supporting surface to erect the base frame and has a center axle to support long trunk to stand up right straight; multiple branches connect with the long trunk; single or multiple sets of light strings, composed of many lamp bulbs, lamp holders, electrical conductors and receptacles, to be fixed on the branches to establish tree light strings.

### BRIEF DESCRIPTION OF THE DRAWINGS

The detailed descriptions are done accompanying the drawings and preferred embodiments of the present invention:

FIG. 1 is a perspective view with 3-dimention of decorative light strings with combinative tree of the present invention.

FIG. 2 is a perspective view of the preferred embodiment of the connection style of the decorative light strings with combinative tree of the present invention;

FIG. 3 is a perspective view with 3-dimention showing the practical structure of the decorative light strings with combinative tree of the present invention;

FIG. 4 is a perspective view of the preferred embodiment of the connection style of the light string of the decorative light strings with combinative tree of the present invention;

FIG. 5A is a perspective view of stretching out of the base frame of the decorative light strings with combinative tree of the present invention;

FIG. 5B is a perspective view of folding up of the base frame of the decorative light strings with combinative tree of the present invention;

FIG. 6 is a perspective view showing the practical structure of the light string of decorative light strings with combinative tree of the present invention;

FIG. 7A is a perspective view showing the disassembly of the short pipe of decorative light strings with combinative tree of the present invention;

FIG. 7B is a perspective view showing the assembly of the short pipe of decorative light strings with combinative tree of the present invention;

### DETAILED DESCRIPTION OF THE PREFERRED EMBODIMENTS

For the convenience of the description, the same composing part is to show the same number in the drawings.

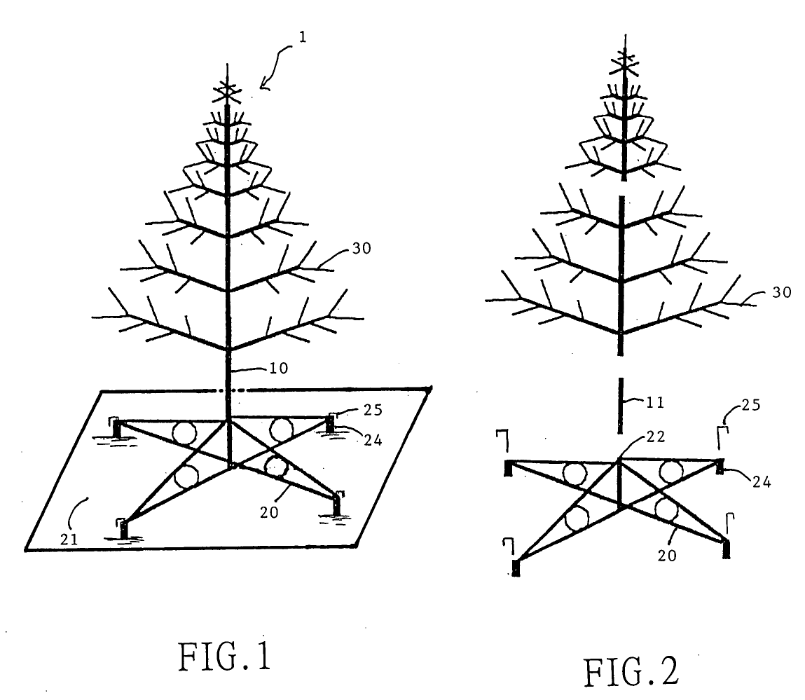

Now, referring to FIG. 1, it is a perspective view of the decorative light strings with combinative tree of the present invention. The structure of this combinative tree 1 includes a supporting surface 21, a base frame 20, a long trunk 10 and multiple branches 30; the base frame 20 is supported by the terminal base part, said base part having fastening ring 241 is fixed on the supporting surface 21 by using the pin 25; base frame 20 having center axis 22 to connect with the long trunk 10, said long trunk 10 is composed of many short pipes. The height of tree body can be adjustable by the number of the short pipe. There are many branches 30 connected to the long trunk 10 so as to form a structure of combinative tree.

FIG. 2 relates to the connection style of the decorative light strings with combinative tree of the present invention. The base frame 20 has the center axle 22 to support the main trunk to stand up right. Between the main trunk and base frame, the hollow short pipe 11 did not attach with branch and light string to increase the distance between this light string and support surface. The multiple branches 30 connect on the long trunk.

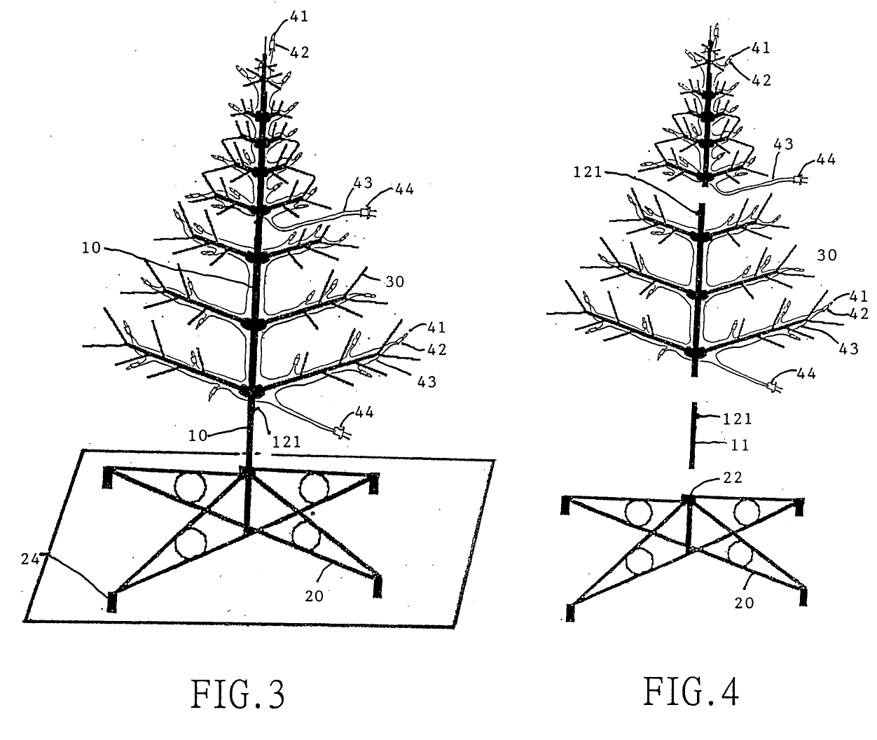

FIG. 3 is a perspective view with 3-dimention showing the practical structure of the decorative light strings with combinative tree of the present invention. The present decorative light strings with combinative tree 1 includes long trunk 10 connected by many hollow short pipes 11. Said hollow short pipe 11 has connected tenon (not shown) for easy to fix it tightly. The amount of the short pipes 11 decides the height of tree body. The base frame 20 supported on the supporting surface 21 has the center axle 22 to support the main long trunk 10 to stand up right. The multiple branches 30 connect on the long trunk 10. Single or many sets of light strings 40 are composed of many lamp bulb 41, lamp holder 42, electrical conductor 43 and receptacles 44 to be fixed on the branches 30 to establish tree light.

FIG. 4 relates to the connection style of the light string of the decorative light strings with combinative tree of the present invention. The base frame 20 has the center axle 22 to support the main long trunk to stand up right. Between the main long trunk and base frame, the hollow short pipe 11 did not attach with branch and light string to increase the distance between this light string and supporting surface. The multiple branches 30 connect on the long trunk.

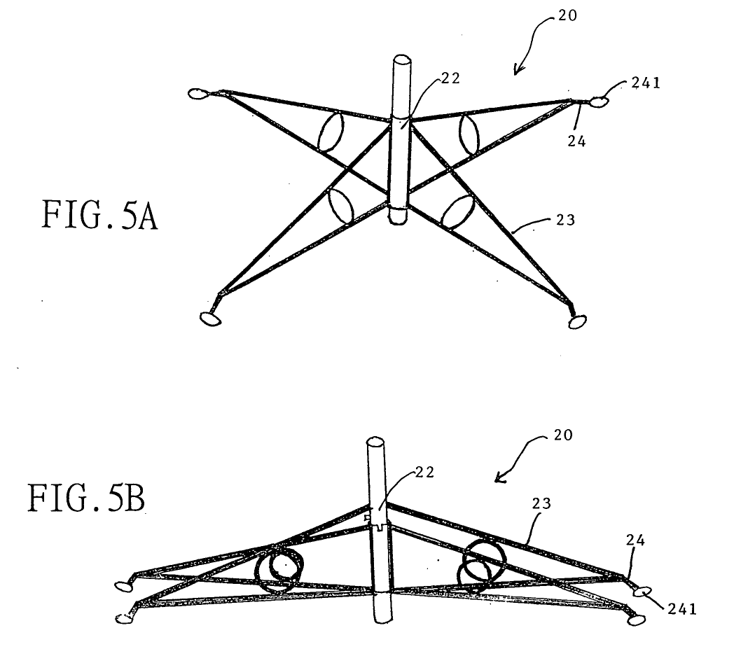

FIG. 5A is a perspective view of stretching out of the base frame of the decorative light strings with combinative tree of the present invention. The base frame 20 is composed of many branch frames 23. Said base frame is to stretch out or to fold up from center axle 22. The terminal end of branch frame 23 has a base part 24 attached fastening ring 41. The pin via the fastening ring 241 is to nail into the support surface to fix the base frame 20.

FIG. 5B is a perspective view of folding up of the base frame 20 of the decorative light strings with combinative tree of the present invention. From the center axle 22, many branch frames 23 fold up together to reduce the volume. The base part 24 of branch frame is equipped at the end of many branch frames 23, and is attached with fastening ring 241 whereby to accept the pin 25.

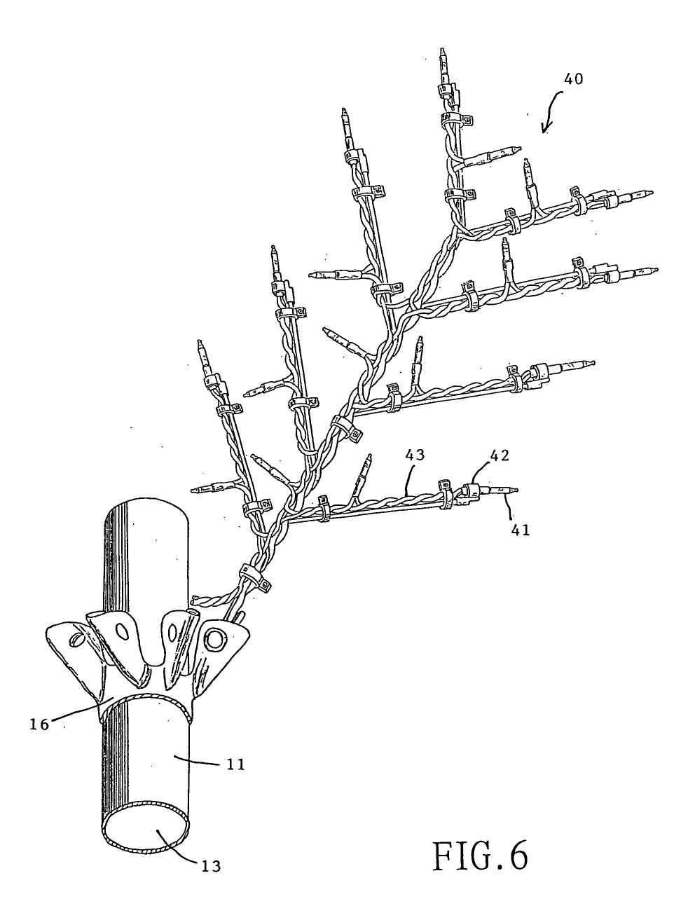

FIG. 6 is a perspective view showing the practical structure single or many sets of light string 40 of decorative light strings with combinative tree of the present invention. Said single or many sets of light string 40 are connected with many short pipes 11. The connecting ring 16 on the short pipe 11 is used to connect the branches, and light string 40 is attached on the branches with their shape. The light string 40 is composed of lamp bulb 41, lamp holder 42, electrical conductor 43 and receptacle 44.

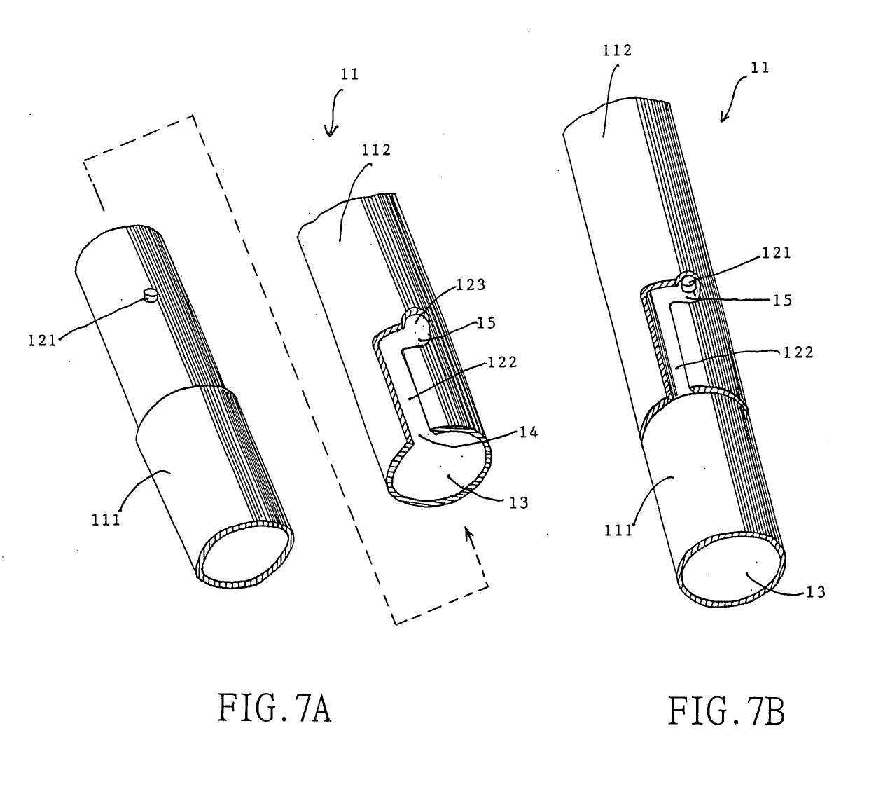

FIG. 7A is a perspective view showing the disassembly of the hollow short pipe 11 of decorative light strings with combinative tree of the present invention. An outer rim 111 of one end of the hollow short pipes at the predetermined distance of the open end 13 having a flange 121. An outer rim 112 of another end has a predetermined length of L-indentation 122 from the open end extending and matching the position of the flange. From the end having the flange, said flange is to aim at the open end of the L-opening 14 of another short pipe, to fit into the right position, then to rotate it to L-tail 15 and to fix it tightly.

FIG. 7B is the drawing showing the assembly of the hollow short pipe 11 of decorative light strings with combinative tree of the present invention. The hollow short pipe 11 has L-tail 15, already on the enlarged part 123 to fix the flange 121 tightly to form short pipe 11.

From the foregoing it will be appreciated that although specific embodiments of the invention have been described herein for purposed of illustration, various modifications and improvements thereon will become readily apparent to those skilled in the art. Accordingly, the appended claims are to be construed broadly and in a manner consistent with the spirit and scope of the invention described herein.

### Symbol Lists

1 light strings

10 long trunk

11 short pipe

111,112 outer rim

121 flange

122 L-indentation

13 open end

14 L-opening

15 L-tail

16 connecting ring

17 short hollow pipe

20 base frame

21 supporting surface

22 center axle

23 branch frame

24 base part

241 fastening ring

25 pin

30 multiple branches

40 single or multiple light strings

41 lamp bulb

42 lamp holder

43 electrical conductor

44 receptacle

What I claimed is:

1. A decorative light strings with combinative tree including:
long trunk: composed of many short pipes, the height of tree lamp being adjustable by the number of the short pipe;
base frame: using a support surface to erect the base frame and having a center axles to support long trunk to stand up right straight;
multiple branches: connecting with the long trunk;
single or multiple sets of light strings: composed of many lamp bulbs, lamp holders, electrical conductors and receptacles, to be fixed on the branches to establish tree light strings.

2. A decorative light strings with combinative tree as claimed in claim 1, wherein the long trunk being composed of many hollow short pipes to be connected with each other.

3. A decorative light strings with combinative tree as claimed in claim 2, wherein the hollow short pipes to be manufactured by metal.

4. A decorative light strings with combinative tree as claimed in claim 2, wherein the hollow short pipes having tenon for the convenience to fix it.

5. A decorative light strings with combinative tree as claimed in claim 4, wherein an outer rim of one end of the short pipes at the predetermined distance of the open end having a flange, another end having a predetermined length of L-indentation from the open end extending and matching the position of the flange, from the end having the flange, said flange being to aim at the open end of the L-indentation of another short pipe, to fit into the right position, then to rotate it to L-tail and to fix it tightly.

6. A decorative light strings with combinative tree as claimed in claim 5, wherein the base part of L-indentation of the short pipe having an enlarge area so that the flange can be dovetailed into the enlarged area so as not to upside down and depart.

7. A decorative light strings with combinative tree as claimed in claim 1, wherein the short pipes on the long trunk providing with one or more connecting rings to connect with many branches.

8. A decorative light strings with combinative tree as claimed in claim 1, wherein the base frame to be composed of many branch frames and to be able to stretch out or to fold up from the center axle.

9. A decorative light strings with combinative tree as claimed in claim 8, wherein the base part of branch frame having fastening ring and the pin being going through said fastening ring to nail into supporting surface and to fix the base frame.

10. A decorative light strings with combinative tree as claimed in claim 8, wherein the base frame to be stretched out from the center axle and base frame being not fallen on a certain angle of supporting surface.

11. A decorative light strings with combinative tree as claimed in claim 8, wherein the support surface used to erect the base frame able to be indoor and out door floor.

12. A decorative light strings with combinative tree as claimed in claim 8, wherein the support surface used to erect the base frame able to be soften and hard floors at out door.

13. A decorative light strings with combinative tree as claimed in claim 1, wherein the hollow short pipe between the main trunk and base frame being not attached with branch and light string to increase the distance between this light string and support surface.

14. A decorative light strings with combinative tree as claimed in claim 1, wherein the light string attached to the protection device, transformer or functional control device to increase the decorative function.

15. A decorative light strings with combinative tree including:
long trunk: composed of many short pipes, the height of tree lamp can be adjustable by the number of the short pipe; an outer rim of one end of the hollow short pipes at the predetermined distance of the open end having a flange, another end having a predetermined length of L-indentation from the open end extending and matching the position of the flange, from the end having the flange, said flange being to aim at the open end of the L-indentation of another short pipe, to fit into the right position, then to rotate it to L-tail and to fix it tightly;
base frame: using a support surface to erect the base frame and to have a center axis to support long trunk to stand up right straight;
multiple branches: connecting with the long trunk;
single or multiple sets of light strings: composed of many lamp bulbs, lamp holders, electrical conductors and receptacles, to be fixed on the branches to establish tree light strings.
